(19) United States
(12) Patent Application Publication
(10) Pub. No.: US 2023/0113422 A1
(43) Pub. Date: Apr. 13, 2023

(54) METHOD FOR IDENTIFYING USER INFORMATION IN TRANSACTION AND DEVICE FOR PERFORMING SAME

(71) Applicant: UPPSALAXEN, Seoul (KR)

(72) Inventors: Hyung Woo KIM, Seoul (KR); Baek Soo KIM, Seoul (KR); Jong Ho KIM, Seoul (KR)

(21) Appl. No.: 17/905,648

(22) PCT Filed: Feb. 23, 2021
(86) PCT No.: PCT/KR2021/002235

§ 371 Date: Sep. 5, 2022

(30) Foreign Application Priority Data
Mar. 5, 2020 (KR) 10-2020-0027494
Oct. 12, 2020 (KR) 10-2020-0131011

(51) Int. Cl. G06Q 20/40; G06Q 20/36; G06Q 20/38; G06Q 20/42; G06Q 30/0601

(52) U.S. Cl. CPC G06Q 20/4014; G06Q 20/36; G06Q 20/382; G06Q 20/389; G06Q 20/42; G06Q 30/0609

(57) ABSTRACT

A method of identifying user information in a transaction and an apparatus for performing the method of identifying user information in a transaction can include transmitting, by an originator virtual asset service provider (O-VASP), a first user confirmation transaction to a beneficiary virtual asset service provider (B-VASP) based on remittance information, receiving, by the O-VASP, a second user confirmation transaction from the B-VASP; and transmitting, by the O-VASP, virtual transaction assets generated based on the remittance information to a beneficiary wallet.

### BACKGROUND

### 1. Field of the Invention

The present invention relates to a method of identifying user information in a transaction and an apparatus for performing the method. More specifically, the present invention relates to a method of identifying user information in a transaction, capable of identifying information about users sending and receiving virtual assets in transfer of virtual assets, and an apparatus for performing the method.

### 2. Discussion of Related Art

The Financial Action Task Force (FATF)'s travel rule provisions on anti money laundering (AML) stipulates the verification of the identity of traders as follows: Exchange A and Exchange B must provide a database of pair information about identifier (ID) information of a sender a and a recipient b and a transaction. Through this, in a situation related to terrorist funds or money laundering in the future, the prosecution or the police may inquire about each exchange to retrieve the information to track the funds and impose sanctions.

According to Recommendation 15, paragraph 7(b), a virtual asset service provider (VASP) sending funds must have the sender's information along with the recipient's information and be able to submit the information when requested by regulatory authorities. A VASP receiving funds also must have the sender's information together with the recipient's information, and be able to submit the information when requested by regulatory authorities.

Therefore, studies on the technology for satisfying the regulations are required.

### SUMMARY OF THE INVENTION

Objects of the present invention are to solve all of the above problems.

In addition, the present invention is directed to providing a method of identifying information about an originator and a beneficiary in a virtual asset transaction.

In addition, the present invention is directed to providing a method of identifying information about an originator and a beneficiary in a virtual asset transaction while simplifying the virtual asset transaction with a simpler procedure.

A representative configuration of the present invention for achieving the above objects is as follows.

According to an aspect of the present invention, there is provided a method of identifying user information in a transaction comprises transmitting, by an originator virtual asset service provider (O-VASP), a first user confirmation transaction to a beneficiary virtual asset service provider (B-VASP) based on remittance information, receiving, by the O-VASP, a second user confirmation transaction from the B-VASP and transmitting, by the O-VASP, virtual transaction assets generated based on the remittance information to a beneficiary wallet.

Meanwhile, the first user confirmation transaction includes beneficiary identification information input by an originator device and the B-VASP determines whether the beneficiary identification information in the first user confirmation transaction is identical to beneficiary identification information stored in the B-VASP.

Further, the second user confirmation transaction includes originator identification information input by a beneficiary device, and the O-VASP determines whether the originator identification information in the second user confirmation transaction is identical to originator identification information stored in the O-VASP.

According to another aspect of the present invention, there is provided an originator virtual asset service provider (O-VASP) for identifying user information in a transaction, the O-VASP comprises a communication unit configured to communicate with a beneficiary virtual asset service provider (B-VASP) and a processor operatively connected to the communication unit, wherein the processor is implemented to transmit a first user confirmation transaction to the B-VASP based on remittance information, receive a second user confirmation transaction from the B-VASP and transmit virtual transaction assets generated based on the remittance information to a beneficiary wallet.

Meanwhile, the first user confirmation transaction includes beneficiary identification information input by an originator device, and the B-VASP determines whether the beneficiary identification information in the first user confirmation transaction is identical to beneficiary identification information stored in the B-VASP.

Further, the second user confirmation transaction includes originator identification information input by a beneficiary device, and the O-VASP determines whether the originator identification information in the second user confirmation transaction is identical to originator identification information stored in the O-VASP.

### BRIEF DESCRIPTION OF THE DRAWINGS

FIG. 1 is a conceptual diagram illustrating a conventional method of transferring virtual assets.

FIG. 2 is a conceptual diagram illustrating a virtual asset transaction system according to an embodiment of the present invention.

FIG. 3 is a hashing method according to an embodiment of the present invention.

FIG. 4 is a conceptual diagram illustrating a method of performing comparison of hash values according to an embodiment of the present invention.

FIG. 5 is a conceptual diagram illustrating a hashing method according to an embodiment of the present invention.

FIG. 6 is a conceptual diagram illustrating a method of entering input information according to an embodiment of the present invention.

FIG. 7 is a conceptual diagram illustrating a method of simplifying virtual asset transfer according to an embodiment of the present invention.

FIG. 8 is a conceptual diagram illustrating a method of simplifying virtual asset transfer according to an embodiment of the present invention.

FIG. 9 is a conceptual diagram illustrating a method for simplifying virtual asset transfer according to an embodiment of the present invention.

FIG. 10 is a method of storing information about an originator and a beneficiary according to an embodiment of the present invention.

FIG. 11 is a conceptual diagram illustrating a virtual asset transfer method according to an embodiment of the present invention.

FIG. 12 is a conceptual diagram illustrating a virtual asset transfer method according to an embodiment of the present invention.

FIG. 13 is a conceptual diagram illustrating a virtual asset transfer method according to an embodiment of the present invention.

### DETAILED DESCRIPTION OF EXEMPLARY EMBODIMENTS

The detailed description of the present invention will be made with reference to the accompanying drawings showing examples of specific embodiments of the present invention. These embodiments will be described in detail such that the present invention can be performed by those skilled in the art. It should be understood that various embodiments of the present invention are different but are not necessarily mutually exclusive. For example, a specific shape, structure, and characteristic of an embodiment described herein may be implemented in another embodiment without departing from the scope and spirit of the present invention. In addition, it should be understood that a position or arrangement of each component in each disclosed embodiment may be changed without departing from the scope and spirit of the present invention. Accordingly, there is no intent to limit the present invention to the detailed description to be described below. The scope of the present invention is defined by the appended claims and encompasses all equivalents that fall within the scope of the appended claims. Like reference numerals refer to the same or like elements throughout the description of the figures.

Hereinafter, in order to enable those skilled in the art to practice the present invention, exemplary embodiments of the present invention will be described in detail with reference to the accompanying drawings.

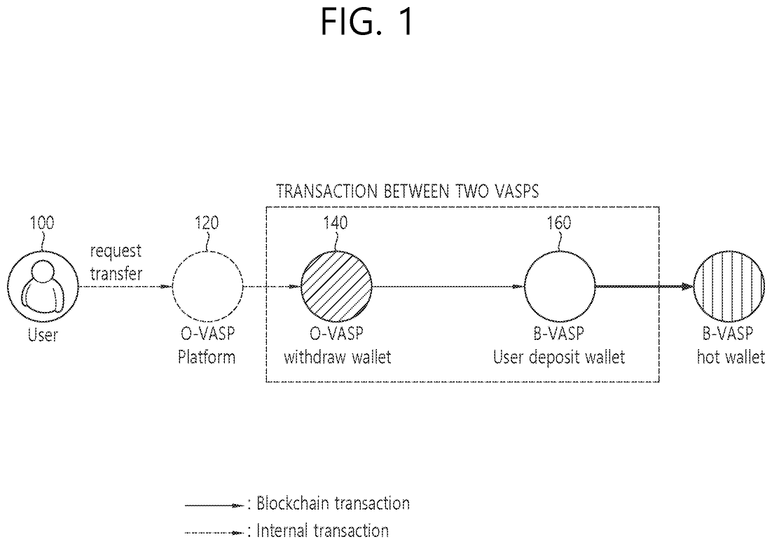

FIG. 1 is a conceptual diagram illustrating a conventional method of transferring virtual assets.

In FIG. 1, the conventional method of transferring virtual assets from a remittance virtual asset service provider (VASP) to a collection VASP is disclosed.

Hereinafter, in an embodiment of the present invention, the remittance VASP may be called an originator (O)-VASP, and the collection VASP may be called a beneficiary (B)-VASP. The O-VASP may be an exchange for remittance procedures, and B-VASP may be an exchange for collection procedures.

Referring to FIG. 1, a remittance user 100 transfers virtual assets to a personal wallet 160 of a collection user of a B-VASP through an O-VASP integrated wallet 140 on an O-VASP 120. In this case, the integrated wallet 140 is not a personal wallet of the remittance user 100, but a withdrawal wallet that provides an integrated use in the O-VASP 120, as a wallet in which an individual is not identifiable.

The existing O-VASP 120 transfers virtual assets from the remittance user 100 to the collection user through the integrated wallet 140 of the O-VASP with information about a personal wallet of the collection user and information about virtual assets to be remitted. That is, the existing O-VASP 120 performs a blockchain transaction through a separate integrated account in consideration of the risk of hacking and management efficiency.

However, such a virtual asset transfer method does not follow the travel rule of the Financial Action Task Force (FATF). In the travel rule, it is required for each of the O-VASP and the B-VASP to obtain remittance user identification information (e.g., the name of a remittance user) and collection user identification information (e.g., the name of a collection user) that may identify the remittance user and the collection user.

While complying with the travel rule, there are restrictions under the current laws: member information cannot be shared between current exchanges; and when an external business operator has the right to access a customer database, it violates the Personal Information Protection Act. Therefore, studies are needed to satisfy the travel rule by acquiring remittance user identification information or collection user identification information related to a transaction between an O-VASP of the remittance user and a B-VASP of the collection user.

Hereinafter, in the embodiments of the present invention, for the sake of convenience of description, terms “remittance” or “collection” are used, but remittance may be expressed as sending (or transfer), and collection may be expressed as receiving (or deposit).

In addition, in the embodiment of the present invention, for the sake of convenience of description, terms “remittance user” and “collection user” are used. However, a remittance user may be used to conceptually include a remittance user device and a collection user may be used to conceptually include a collection user device.

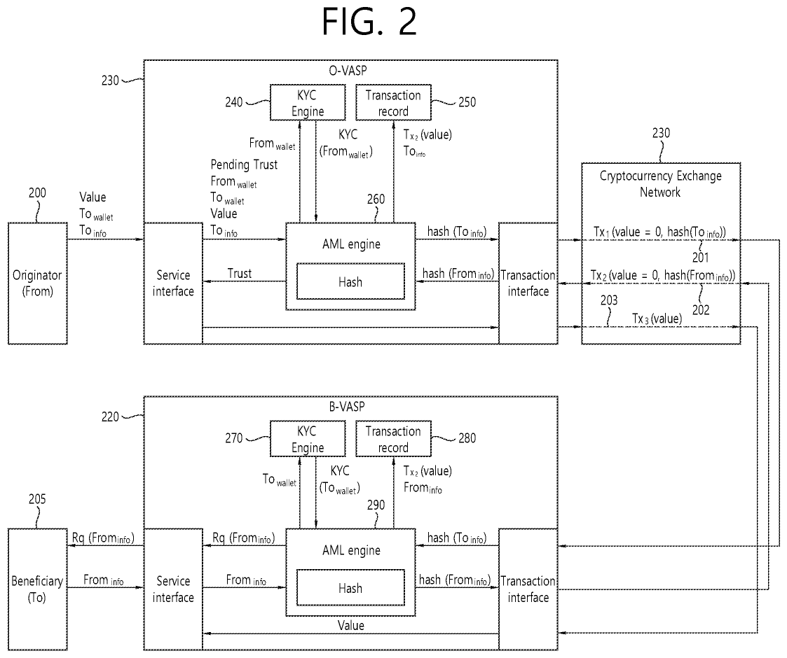

FIG. 2 is a conceptual diagram illustrating a virtual asset transaction system according to an embodiment of the present invention.

In FIG. 2, a system for confirming counterpart user information between VASPs to comply with the travel rule for anti money laundering (AML) is disclosed.

Referring to FIG. 2, a virtual asset transaction system may include a remittance user device 200, a collection user device 205, an O-VASP 210, a B-VASP 220, a virtual asset exchange network 230, know your customer (KYC) engines 240 and 270, transaction records 250 and 280, and AML engines 260 and 290.

The remittance user device 200 may be a device of a remittance user who sends virtual assets. A remittance user may be called an originator.

The collection user device 205 may be a device of a collection user who desires to collect virtual assets. A collection user may be called a beneficiary.

The O-VASP 210 may be a virtual asset remittance server (a virtual asset remittance node or virtual asset remittance exchange) associated with the originator. The originator may remit virtual assets through the O-VASP 210.

The B-VASP 220 may be a virtual asset collection server (a virtual asset collection node or virtual asset collection exchange) associated with the beneficiary. The beneficiary may collect virtual assets through the B-VASP 220.

The virtual asset exchange network (or cryptocurrency (virtual asset) exchange network) 230 may be a network including a node configured to record transactions related to virtual assets in a ledger and generate blocks.

The virtual asset exchange network 230 may be a network for transmitting or receiving a first user confirmation transaction 201, a second user confirmation transaction 202, and a virtual asset transfer transaction 203, which will be described below.

The KYC engines 240 and 270 may be implemented to obtain user information from the O-VASP 210 and the B-VASP 220, respectively, through a procedure, such as KYC, and manage the obtained user information. The KYC engine 240 of the O-VASP 210 may acquire information about an originator and/or a beneficiary related to the O-VASP 210 and manage the acquired information, and the KYC engine 270 of the B-VASP 220 may obtain information about an originator and/or a beneficiary related to the B-VASP 220 and manage the obtained information.

The transaction records 250 and 280 may be implemented to acquire transaction information generated in the O-VASP 210 and the B-VASP 220, respectively, and manage the acquired transaction information. The transaction record 250 of the O-VASP 210 may acquire transaction information generated in the O-VASP 210 and manage the acquired transaction information, and the transaction record 280 of the B-VASP 220 may acquire transaction information generated in the B-VASP 220 and manage the acquired transaction information.

The AML engines 260 and 290 may be implemented to identify user information in a transaction according to an embodiment of the present invention. The AML engines 260 and 290 may be implemented to perform hashing of remittance information and collection information. The hash information may be used for mutual confirmation between the originator and the beneficiary. The AML engines 260 and 290 may acquire information about the originator and the beneficiary connected to the KYC engines 240 and 270 and may generate hash information, and exchange the hash information so that a confirmation procedure between the originator and the beneficiary is performed.

Details of a hashing method and a method of performing mutual confirmation between an originator and a beneficiary based on hash information will be described below.

First, an originator may request a transaction for transferring virtual assets to a beneficiary.

The originator may input a beneficiary's wallet address To_{wallet}, a transaction amount (or a remittance amount) Value, originator identification information (e.g., name) To_{info} and the like through the remittance user device 200. The O-VASP 210 may generate remittance information from an integrated wallet address (From_{wallet}) a beneficiary wallet address To_{wallet}, a transaction amount (or a remittance amount) Value, and beneficiary identification information (e.g., name) (To_{info)} and generate a virtual asset transfer transaction 203 for virtual asset transfer based on the remittance information.

The virtual asset transfer transaction 203 may be temporarily pending for transfer of a first user confirmation transaction 201 and a second user confirmation transaction 202 for a confirmation procedure for a beneficiary and an originator (Pending Trust). The pending virtual transfer transaction 203 may be transmitted after a hash value-based user confirmation procedure (the first user confirmation transaction 201 and the second user confirmation transaction 202) is completed.

Subsequently, the hash value-based user confirmation procedure (the first user confirmation transaction 201 and the second user confirmation transaction 202) may be performed between the O-VASP 210 and the B-VASP 220. The hash value-based user confirmation procedure may be a confirmation procedure for an originator and a beneficiary to satisfy the travel rule described above.

The first user confirmation transaction 201 is a procedure of confirming whether the beneficiary identification information input by the originator is correct, and the second user confirmation transaction 202 is a procedure of confirming whether the originator identification information input by the beneficiary is correct. Through the first user confirmation transaction 201 and the second user confirmation transaction 202, the O-VASP 210 may obtain the beneficiary information, and the B-VASP 220 may obtain the originator information, and thus the travel rule may be satisfied.

Hereinafter, a specific method of transmitting a first user confirmation transaction 201 and a second user confirmation transaction 202 is disclosed.

The O-VASP 210 may generate a hash value to transmit the first user confirmation transaction 201 (Tx1(value=0, hash(To_{info}))) to the B-VASP 220. The first user confirmation transaction 201 may include information obtained by hashing remittance information, and may be used for confirmation of a beneficiary. Since there is no virtual asset transmitted in the first user confirmation transaction 201, the first user confirmation transaction 201 has a value=0, and the beneficiary identification information To_{info} input by the originator is hashed as hash (To_{info}).

In order to increase the difficulty of a random attack during hashing, the hash value may be generated by adding a random number that may be generated equally by both exchanges (the O-VASP and the B-VASP).

The O-VASP 210 has already acquired the identification information of the originator using the O-VASP 210 through the KYC engines 240 and 270, and may also acquire beneficiary identification information through the beneficiary identification information input by the originator.

The first user confirmation transaction 201 may be transmitted to the B-VASP 220 via the virtual asset exchange network.

The B-VASP 220 may receive the first user confirmation transaction 201, and compare the hash value hash (To_{info}) of the beneficiary identification information included in the first user confirmation transaction 201 with a hash value of beneficiary identification information stored in the B-VASP 220 to check whether the beneficiary identification information input by the originator is correct.

Specifically, the AML, engines 260 and 290 of the B-VASP 220 may obtain beneficiary identification information KYC (To_{wallet}) through the KYC engines 240 and 270 based on the information about the beneficiary personal wallet address To_{wallet} included in the first user confirmation transaction 201. Thereafter, the beneficiary identification information KYC (To_{wallet}) is hashed to hash (KYC (To_{wallet})), and it is determined whether the hashed beneficiary identification information is the same as the hash value hash (To_{info}) included in the first user confirmation transaction 201. In order to determine the equivalence of information through hash value comparison, the same hash function may be used in both exchanges (the O-VASP and the B-VASP), and additionally, random number values that may be equally generated by both exchanges (the O-VASP and the B-VASP) may be added to strengthen security.

The hash value, i.e., hash (KYC (To_{wallet}), which is hashed from the personal information KYC (To_{wallet}), may be called a first hash value (B-VASP) and the hash value, hash (To_{info)}, which is included in the first user confirmation transaction, may be called a first hash value (O-VASP).

The first hash value (B-VASP) and the first hash value (O-VASP) being the same may mean that the beneficiary identification information specified by the originator is correct.

When the first hash value (O-VASP) and the first hash value (B-VASP) are not the same, a second user confirmation transaction (failure) 202 indicating a failure to confirm the beneficiary may be transmitted to the O-VASP 210. The second user confirmation transaction (failure) 202 may be transmitted by further including the beneficiary identification information KYC (To_{wallet}) indicated by the first user confirmation transaction 201.

Conversely, when the first hash value (O-VASP) and the first hash value (B-VASP) are the same, the B-VASP 220 may request originator identification information from the beneficiary and transmit a second user confirmation transaction (success) 202 including hashed information of the originator identification information to the O-VASP 210. When there has been a transaction between the originator and the originator in the past, a request for the originator identification information may not be separately made to the originator. In the case of determination of an initial transaction or an abnormal transaction, a request for originator identification information may be separately made to the beneficiary to determine whether the beneficiary can identify the originator. Such a simplified virtual asset transfer method will be described below.

The second user confirmation transaction (success) 202 may be utilized for confirmation of the originator on the O-VASP 210. The hashed originator identification information included in the second user confirmation transaction (success) 202 may be compared with a hashed result of the originator identification information stored in the KYC engine 240 of the O-VASP 210.

The hashed originator identification information included in the second user confirmation transaction (success) 202 is a second hash value (B-VASP) and the hashed result of the originator identification information obtained through the KYC engine 240 of the O-VASP 210 may be a second hash value (O-VASP). The second hash value (B-VASP) and the second hash value (O-VASP) being the same may mean that the originator identification information specified by the beneficiary is correct.

When a result of the comparison in the O-VASP 210 is that the second hash value (B-VASP) and the second hash value (O-VASP) are the same hash value, the pending virtual asset transfer transaction 203 may be transmitted so that virtual assets may be delivered from the originator to the beneficiary. Before the transfer of the virtual assets, the balance of the originator may be checked to determine whether a normal transaction is possible. Information about the completed virtual asset transfer transaction 203 may be stored in the O-VASP 210 and the B-VASP 220. The O-VASP 210 may store the beneficiary identification information (e.g., a wallet address, a name, and an exchange) received from the originator, and the B-VASP 220 may store the originator identification information (e.g., a wallet address, a name, and an exchange) received from the beneficiary.

That is, before the transaction, the O-VASP 210 stores only the information about the originator, and the B-VASP 220 stores only the information about the beneficiary. After the transaction, the O-VASP 210 may receive the beneficiary identification information from the originator and separately store the received beneficiary identification information, and the B-VASP 220 may receive the originator identification information from the beneficiary and separately store the received originator identification information.

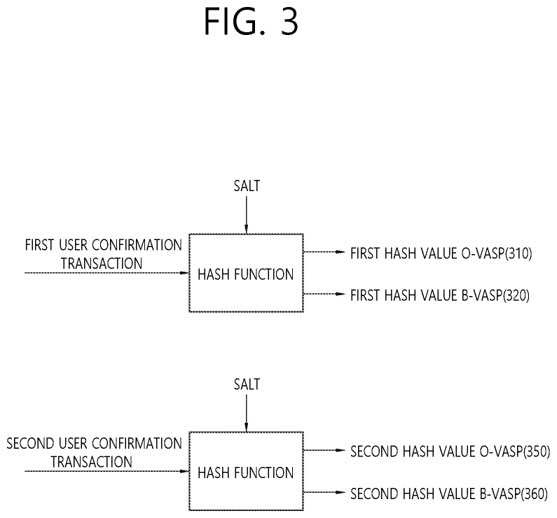

FIG. 3 is a hashing method according to an embodiment of the present invention.

In FIG. 3, a method of generating the above described first hash value (O-VASP), first hash value (B-VASP), second hash value (O-VASP), and second hash value (B-VASP) is disclosed.

Referring to FIG. 3, a hashing (or hash encryption) algorithm is a one-way encryption method. Therefore, in principle, it is impossible to restore original data with only a hash value. Since the hash value changes with a very small change in data, the hash value may be used to check whether information matches or not. For example, when a password of a user is stored in the server, leakage of server data may lead to leakage of a password pair of the user, which causes a big security problem. To solve the security problem, a hashed password (hash) is stored in the server, and when a user inputs a password (input) to log in, the password is hashed with the same hash function to compare a hash value of the password (input) with the password (hash) to check whether the passwords match.

As the hash algorithm, algorithms, such as MDS, SHA-1, SHA-256, and SHA-512, may be used. However, when the type of hash function is known and the field of the value to be entered is known, there is a possibility that an input value is found through a brute force attack, so there is a need for supplementation.

Therefore, in the embodiment of the present invention, a method of generating a hash value by adding a salt, which is an arbitrary character string, to plaintext is used. By using a salt value, it is possible to defend against a rainbow attack that compares pre-made original text with a combination of hashes.

Specifically, in the present invention, a salt (a random value) that may be equally generated by different VASPs (the O-VASP and the B-VASP) is hashed to maintain higher security. The two VASPs may perform prior agreement on the salt used for hashing, the number of iterations, and the like. The salt value may be generated with an algorithm, such as a one time password (OTP) based on customer information and a generation time.

A first hash value (O-VASP) 310 and a first hash value (B-VASP) 320 may be generated based on the same hash function and salt value, and similarly, a second hash value (O-VASP) 350 and a second hash value (B-VASP) 360 may be generated based on the same hash function and salt value.

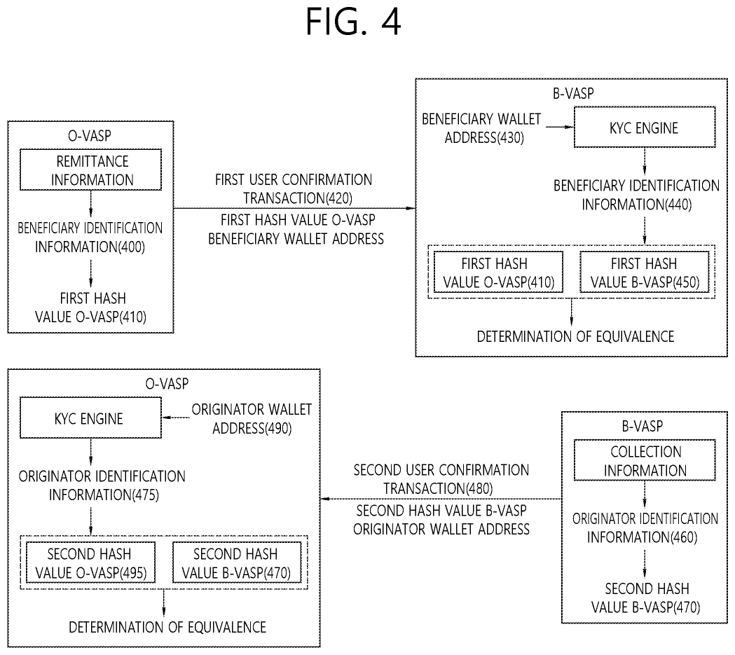

FIG. 4 is a conceptual diagram illustrating a method of performing comparison of hash values according to an embodiment of the present invention.

In FIG. 4, a method of comparing the equivalence of information through a comparison of a first hash value (O-VASP) and a first hash value (B-VASP) and a comparison of a second hash value (O-VASP) and a second hash value (B-VASP) is disclosed.

Referring to the upper part of FIG. 4, a method of comparing a first hash value (O-VASP) 410 with a first hash value (B-VASP) 450 is disclosed.

As described above, as remittance information, an integrated wallet address From_{wallet} of the O-VASP, a beneficiary wallet address To_{wallet}, a transaction amount (or a remittance amount) Value, and beneficiary identification information (e.g., a name) To_{info} 400 may be generated in the O-VASP.

The first hash value (O-VASP) 410 may be a hash value for the beneficiary identification information (e.g., name) To_{info} 400. The first hash value (O-VASP) 410 may be included in a first user confirmation transaction 420 and transmitted to the B-VASP.

The first user confirmation transaction 420 transmitted to the B-VASP may further include information about the O-VASP integrated wallet address From_{wallet}, the beneficiary wallet address To_{wallet} 430, or the transaction amount (or remittance amount) Value.

The B-VASP may acquire beneficiary identification information 440 corresponding to the beneficiary device through the KYC engine based on the beneficiary wallet address Towallet 430 included in the first user confirmation transaction 420.

That is, a value obtained by hashing the beneficiary identification information input by the originator device is the first hash value (O-VASP) 410, and a value obtained by hashing the beneficiary identification information 440 obtained through the KYC engine of the B-VASP is the first hashed value (B-VASP) 450. For the sake of convenience of understanding, the first hash value (O-VASP) 410 may be called first beneficiary identification information (hash), and the first hash value (B-VASP) may be called second beneficiary identification information (hash).

The first beneficiary identification information (hash) (i.e., the first hash value (O-VASP) 410) and the second beneficiary identification information (hash) (i.e., the first hash value (B-VASP) 450) may be hashed values based on the same hash function and the same random value (salt value). By comparing the first beneficiary identification information (hash) with the second beneficiary identification information (hash), it may be determined whether the beneficiary identification information input by the originator and the beneficiary identification information on the B-VASP are the same.

Referring to the lower part of FIG. 4, a method of comparing a second hash value (O-VASP) 495 with a second hash value (B-VASP) 470 is disclosed.

As described above, when the first hash value (O-VASP) 410 and the first hash value (B-VASP) 450 are the same, the B-VASP 220 may request originator identification information 460 from the beneficiary and transmit a second user confirmation transaction (success) 480 including a hashed result of the originator identification information 460 to the O-VASP.

The second user confirmation transaction (success) 480 may include the hashed originator identification information 480 and information for specifying the originator. The hashed originator identification information is the second hash value (B-VASP) 470. The information for specifying the originator may include information about an originator wallet address 490 of the originator device and/or a transaction ID of the first user confirmation transaction, which will be described below. In FIG. 4, it is assumed that the originator is specified by the originator wallet address 490 for the sake of convenience of description.

For example, the O-VASP may determine originator identification information 475 corresponding to the originator through the KYC engine based on the originator wallet address 490 included in the second user confirmation transaction (success) 480, and hash the originator identification information 475 to generate the second hash value (O-VASP) 495.

That is, a value obtained by hashing the originator identification information 460 inputted by the beneficiary and hashed may be the second hash value (B-VASP) 470, and a value obtained by hashing the originator identification information 475 obtained through the KYC engine of the O-VASP may be the second hash value (O-VASP) 495.

For the sake of convenience of understanding, the second hash value (B-VASP) 470 may be called first originator identification information (hash), and the second hash value (O-VASP) 495 may be called second originator identification information (hash). The first originator identification information (hash) and the second originator identification information (hash) may be hashed based on the same hash function and the same random number value (salt value). By comparing the first originator identification information (hash) with the second originator identification information (hash), it may be determined whether the originator identification information input by the beneficiary and the originator identification information on the O-VASP are the same.

With such a hash value comparison procedure described above, it may be confirmed whether the originator is specified by the beneficiary and whether the beneficiary is specified by the originator, and the O-VASP and B-VASP may acquire the originator identification information and the beneficiary identification information and satisfy the travel rule.

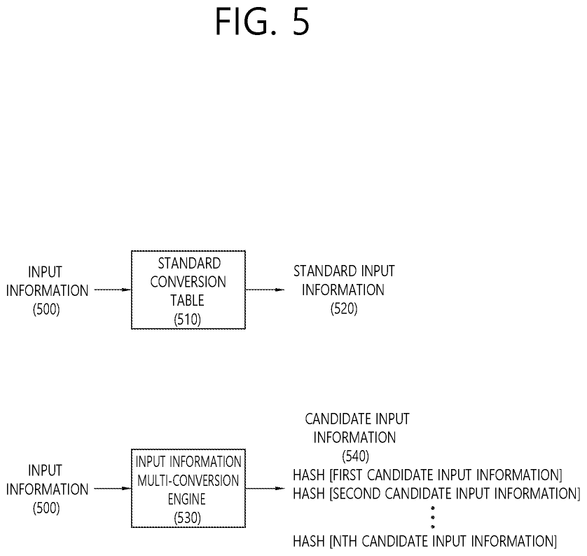

FIG. 5 is a conceptual diagram illustrating a hashing method according to an embodiment of the present invention.

In FIG. 5, a method of performing hashing on information entered by an originator device and a beneficiary device is disclosed.

Referring to FIG. 5, in performing hashing, a hash value changes sensitively to small data changes, and thus errors in some inputs may cause a virtual asset transfer to fail.

Accordingly, there is a need for a method of solving a problem caused by errors in some inputs that may be generated by the originator device and/or the beneficiary device. For the sake of convenience of description, remittance information input by the originator device or collection information input by the beneficiary device are called input information.

In the present invention, in order to minimize a virtual asset transfer failure due to an input error, input information may be subjected to a standardization procedure.

For example, there may be a case in which, in addition to an official name, commonly used names, such as abbreviations and nicknames, exist for the purpose of convenience or the like, or there may be a case in which the company name is changed. For example, IBM is known by various names, such as International Business Machines Corporation, International Office Equipment Company, IBM Corp, and the like.

In this case, since hash algorithms have a characteristic of representing a completely different value only with small changes in data on the input information, the similarity of input information cannot be determined after hashing. Accordingly, input information 500 is converted into standard input information 520, and the standard input information 520 is changed into a hash value through a hash function to obtain the first hash value (O-VASP), the first hash value (B-VASP), the second hash value (O-VASP), and the second hash value (B-VASP) as described above.

In order to convert the input information 500 into the standard input information 520, a standard conversion table 510 may be used. The standard conversion table 510 may be generated by the originator or the beneficiary, or by information provided by the originator or the beneficiary.

When the standard conversion table 510 is present for the input information 500, the input information 500 may be converted through the standard conversion table 510 into the standard input information 520, and the standard input information 520 may be hashed so that a hash value is generated.

Alternatively, according to an embodiment of the present invention, in order to minimize the virtual asset transfer failure due to an input error, the input information 500 may be multi-converted and the multi-converted input information may be transmitted as a hash value.

For example, the input information 500 may be input to an input information multi-conversion engine 530, and a plurality of pieces of candidate input information 540 may be generated through the input information multi-conversion engine 530. The input information 500 and the plurality of pieces of candidate input information 540 are generated as a plurality of hash values (0: hash [input information], 1: hash [candidate input information 1], 2: hash [candidate input information 2], . . . , and n: hash [candidate input information n]) and transmitted.

The input information multi-conversion engine 530 may be generated based on information about pronunciation rules for input information ({Jihyun, Jiyeon}, {Sooyeon, Suhyeon}, etc.) that is confused with similar pronunciations based on pronunciation, information about previous input errors, and the like, or may be generated through machine learning based on such information.

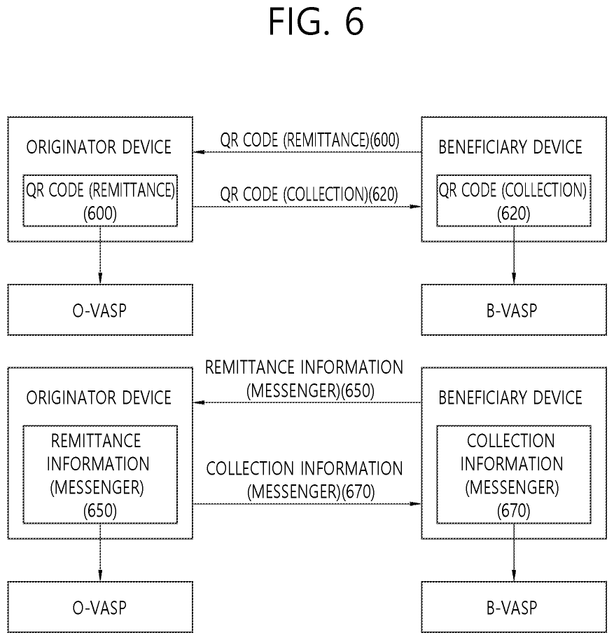

FIG. 6 is a conceptual diagram illustrating a method of entering input information according to an embodiment of the present invention.

In FIG. 6, a method of generating input information without an originator and a beneficiary directly inputting input information is disclosed.

Referring to FIG. 6, a method of inputting input information by an originator and a beneficiary through different media is disclosed.

A method of inputting input information using identification information, such as a quick response (QR) code, may be used.

The originator may request a QR code (remittance) 600 for remittance from the beneficiary, and the QR code (remittance) 600 may include beneficiary identification information and/or beneficiary wallet information.

The originator device may recognize the QR code (remittance) 600 on the O-VASP to generate remittance information, and in this case, a separate input of remittance information by the originator may not be required.

Conversely, the beneficiary device may also request a QR code (collection) 620 for collection from the originator device, and the QR code (collection) 620 may include originator identification information and/or originator wallet information.

The beneficiary may recognize the QR code (collection) 620 on the B-VASP to generate collection information, and in this case, a separate input of collection information by the beneficiary may not be required.

Alternatively, a method of inputting input information using a messenger may be used.

The originator may request remittance information (messenger) 650 for remittance from the beneficiary through a messenger, and the remittance information (messenger) 650 may include beneficiary identification information and/or beneficiary device wallet information. For example, the remittance information (messenger) 650 may be information obtained by clicking on the messenger.

The originator may input the remittance information (messenger) 650 on the O-VASP to generate remittance information, and in this case, a separate input of remittance information by the originator may not be required.

Conversely, the beneficiary may request collection information (messenger) 670 for collection from the originator through a messenger, and the collection information (messenger) 670 may include originator identification information and/or originator wallet information. The collection information (messenger) 670 may be information obtained by clicking on the messenger.

The beneficiary may input the collection information (messenger) 670 on the B-VASP to generate collection information. In this case, a separate input of collection information by the beneficiary may not be required.

The QR codes (remittance, collection), the remittance information (messenger), and the collection information (messenger) may be encrypted and transmitted in a form that may be recognized only by the counterpart VASP or the counterpart user. For example, the QR codes (remittance, collection), the remittance information (messenger), and the collection information (messenger) are encrypted with an exchange's public key, so that the QR codes (remittance, collection), the remittance information (messenger), and the collection information (messenger) may be implemented to be confirmed only with an exchange's private key.

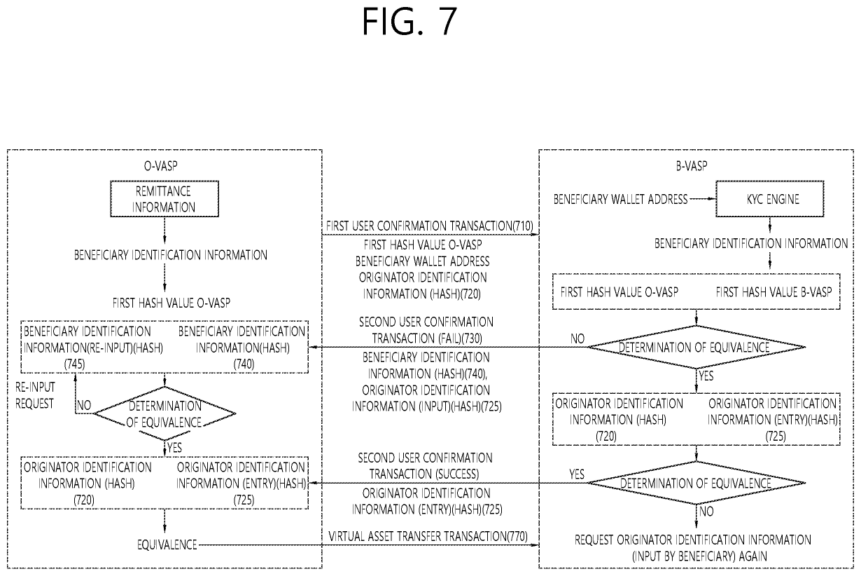

FIG. 7 is a conceptual diagram illustrating a method of simplifying virtual asset transfer according to an embodiment of the present invention.

In FIG. 7, a method of simplifying a virtual asset transfer procedure by changing the agent of confirming an originator and a beneficiary is disclosed.

Referring to FIG. 7, when the first user confirmation transaction is transmitted, originator identification information may be additionally transmitted as remittance information.

As described above, when the first hash value (O-VASP) and the first hash value (B-VASP) are the same, the beneficiary may input originator identification information and transmit the originator identification information to the O-VASP so that the originator is specified. When the specifying of the originator by the beneficiary fails, the second hash value (O-VASP) and the second hash value (B-VASP) are not the same, so the virtual asset transfer may fail. When the virtual asset transfer fails, the operation may need to start again from the transmission of the first user confirmation transaction, which may increase unnecessary congestion of the blockchain network due to input errors.

Therefore, in order to solve the problem caused by an input error in the confirmation procedure in the B-VASP without a separate transfer on a blockchain network, originator identification information (hash) 720 may be additionally included as remittance information and transmitted when transmitting a first user confirmation transaction 710. The originator identification information (hash) 720 may be a value obtained by applying a hash function to originator identification information.

The B-VASP may compare originator identification information (input) (hash) 725 input by the beneficiary with the originator identification information (hash) 720 included in the first user confirmation transaction 710 to notify the beneficiary whether there is an input error in advance. In this way, unnecessary transactions on the blockchain are prevented, and input errors of the beneficiary may be corrected.

In addition, when the first user confirmation transaction 710 is transmitted, an error in inputting beneficiary identification information by the originator may occur. In this case, the originator needs to start again from the procedure of transmitting the first user confirmation transaction. In order to avoid repeating procedures, a simplified virtual asset transfer procedure may be performed as follows.

When an error in inputting beneficiary identification information by the originator occurs, the first hash value (O-VASP) and the first hash value (B-VASP) may not be the same, a second user confirmation transaction (failure) 730 indicating a failure to confirm the beneficiary may be transmitted to the O-VASP.

In order to correct the error in inputting beneficiary identification information by the originator, the second user confirmation transaction (failure) 730 may include beneficiary identification information (hash) 740 obtained by hashing beneficiary identification information.

The O-VASP may request the originator to re-input beneficiary identification information due to the input error. Beneficiary identification information (re-input) (hash) 745 obtained by hashing the beneficiary identification information (re-input) re-input by the originator is compared with the beneficiary identification information (hash) 740 included in the second user confirmation transaction (failure) 730 to determine the equivalence thereof. Through the procedure, unnecessary transmission of the first user confirmation transaction due to a continuous input error of beneficiary identification information by the originator may be prevented

When the correct beneficiary identification information (input) (hash) 745 is input by the originator within a threshold number of re-inputs, a pending virtual asset transfer transaction may be transmitted. That is, even when the originator causes an input error of beneficiary identification information, a pending virtual asset transfer transaction 770 may be immediately transmitted without transmitting the first user confirmation transaction again if the error inputted at the O-VASP stage is corrected, so that the procedure may be simplified.

Specifically, when accurate beneficiary identification information is input by the originator within a threshold number of re-inputs, the pending virtual asset transfer transaction may be immediately transmitted if the originator identification information (input) (hash) 725 generated by the beneficiary is included in the second user confirmation transaction (failure) and thus is confirmed to be the same as the originator identification information (hash) 720 obtained based on the KYC of the O-VASP. Alternatively, when accurate beneficiary identification information is input by the originator within a threshold number of re-inputs, the pending virtual asset transfer transaction 770 may be immediately transmitted if information identifying that the originator identification information (input) (hash) 725 generated by the beneficiary is confirmed to be the same as the originator identification information (hash) included in the first user confirmation transaction 720 on the B-VASP is included in the second user confirmation transaction (failure) 730.

In addition, according to an embodiment of the present invention, when identification information of a counterparty user who performs entry is wrong more than a limit of the number of re-entries, a user with a high level of personal information is requested to input high-level additional user identification information, such as a name, a date of birth, a phone number, an address, etc., and the equivalence of hash values based on the additional user identification information may be checked.

The above described simplified virtual asset transfer procedure may be selectively used to correct input errors without retransmitting a transaction in response to an input error during virtual asset transfer. The simplified virtual asset transfer procedure may be selectively performed in consideration of congestion of the blockchain network, a transaction amount, and the like.

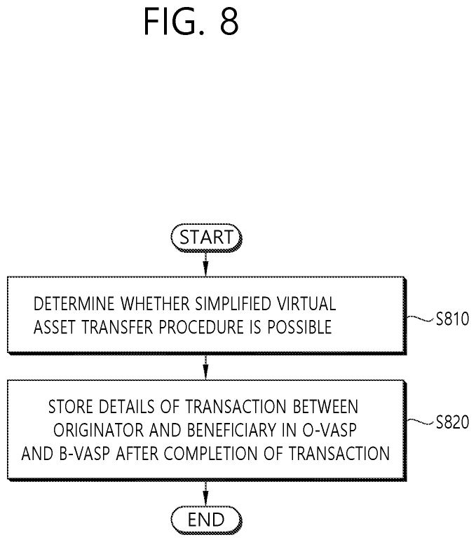

FIG. 8 is a conceptual diagram illustrating a method of simplifying virtual asset transfer according to an embodiment of the present invention.

In FIG. 8, a simplified virtual asset transfer procedure in the case of an existing transaction history between an originator and a beneficiary is disclosed.

Referring to FIG. 8, it is determined whether a simplified virtual asset transfer procedure is possible (S810).

When there is an existing transaction history between the originator and the beneficiary, a simplified virtual asset transfer procedure may be performed without the first user confirmation transaction and the second user confirmation transaction. In other words, the virtual asset transfer transaction may be immediately set to a trust state rather than a trust pending state, and transmitted.

Specifically, the originator may select a beneficiary who has previously made a transaction. Due to the existing transaction, beneficiary identification information is stored in the O-VASP, and since the beneficiary identification information is confirmable, the travel rule is satisfied.

The B-VASP may receive a virtual asset transfer transaction, and omit a procedure of confirming the originator by the beneficiary, or perform a procedure of confirming the originator by the beneficiary only on the B-VASP without a separate transaction.

For example, when the wallet address of the originator device is a specific wallet address rather than an exchange wallet, the originator identification information may be obtained based on the virtual asset transfer transaction, and thus a separate procedure for confirming the originator may not be performed.

Alternatively, when performing the simplified virtual asset transfer procedure, hashed originator identification information may be included in the virtual asset transfer transaction. The hashed originator identification information may be compared with originator identification information obtained by hashing information about the existing counterparties of the beneficiary and when the same originator is specified, the virtual asset transfer may be validated.

Alternatively, when performing the simplified virtual asset transfer procedure, hashed originator identification information may be included in the virtual asset transfer transaction. The beneficiary may select an originator among the existing transaction counterparties, perform hashing, and compare the result with the hashed originator identification information to validate the virtual asset transfer.

Similarly, details of the transaction between the originator and the beneficiary may be stored on the O-VASP and the B-VASP after the transaction is completed (S820).

When the simplified virtual asset transfer procedure is not possible, the virtual asset transfer may be performed through the above described virtual asset transfer procedure.

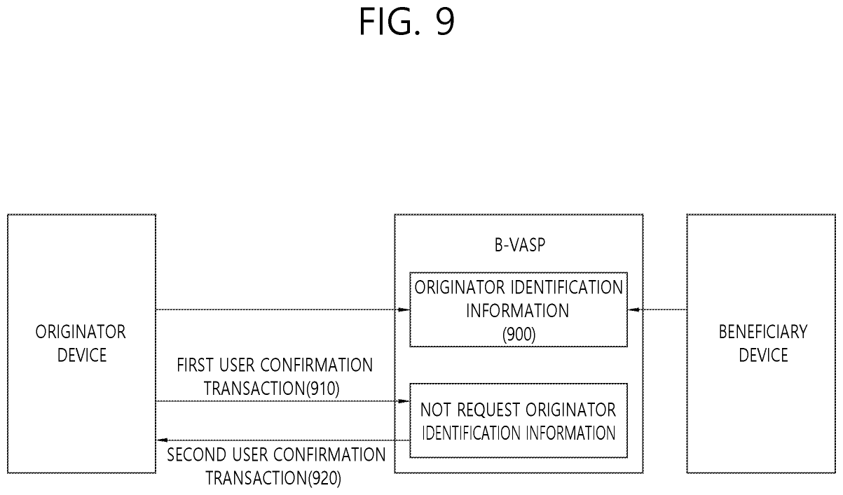

FIG. 9 is a conceptual diagram illustrating a method for simplifying virtual asset transfer according to an embodiment of the present invention.

In FIG. 9, a simplified virtual asset transfer procedure in a case where originator identification information is provided to a B-VASP in advance is disclosed.

Referring to FIG. 9, in a case where the beneficiary provides the B-VASP with originator identification information 900 in advance, or the originator provides the B-VASP with originator identification information 900 in advance, a second user confirmation transaction 920 may be transmitted after receiving a first user confirmation transaction 910, without a request for originator identification information, to the beneficiary.

With such a method, the beneficiary is not requested to identify the originator, so that the virtual asset transfer procedure may be further simplified.

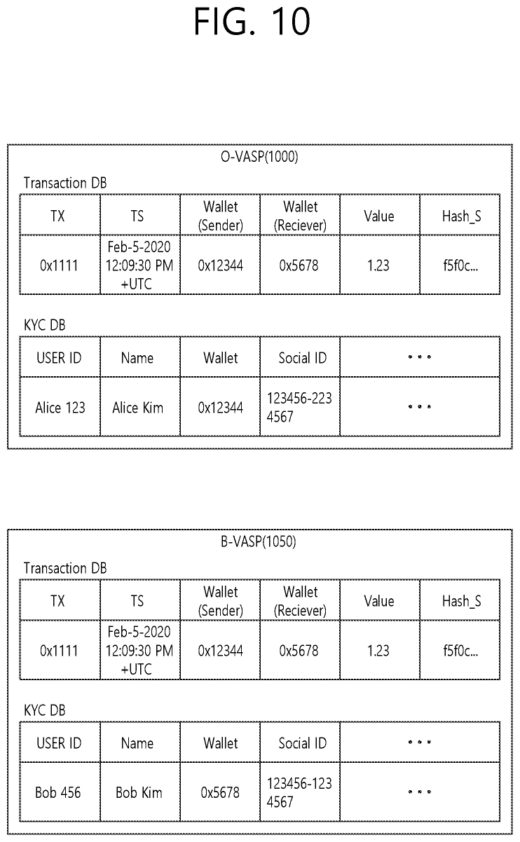

FIG. 10 is a method of storing information about an originator and a beneficiary according to an embodiment of the present invention.

Referring to FIG. 10, the balance of the originator may be checked to check whether a normal transaction is possible and then a virtual asset transfer transaction may be transmitted as described above.

With regard to a transaction completed by virtual transfer transaction transmission, in addition to transaction information, information (a wallet address, a name, and an exchange) about the originator input by the beneficiary (or B-VASP) may be stored in an O-VASP 1000, and information (a wallet address, a name, and an exchange) about the beneficiary input by the originator (or O-VASP) may be stored in the B-VASP 1050.

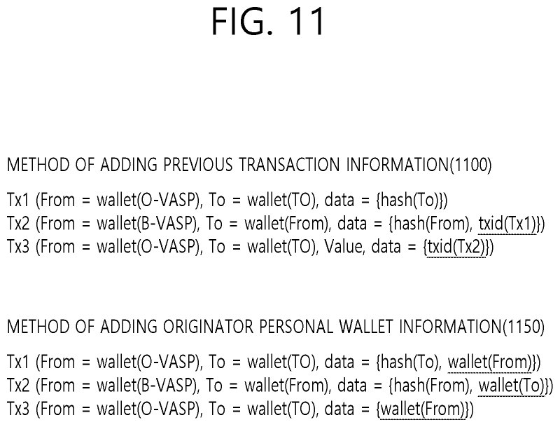

FIG. 11 is a conceptual diagram illustrating a virtual asset transfer method according to an embodiment of the present invention.

In FIG. 11, a method of specifying an originator device when transferring virtual assets is disclosed.

Referring to FIG. 11, when the O-VASP receives a remittance request from an originator, remittance is generally performed in an integrated wallet of the O-VASP. The integrated wallet is a wallet of the O-VASP, in which individuals are not specified. A collection wallet that receives the remittance on the B-VASP may be a personal wallet set for each beneficiary to distinguish the beneficiary who performs collection.

In this case, there is a problem that the originator may not be specified with address information of the integrated wallet when a remittance transaction occurs through the integrated wallet of the O-VASP. Therefore, as a method of performing an identification procedure while maintaining the integrated wallet of the existing exchange and the individual wallet that is present for each beneficiary for collection, not only a hash value but also previous transaction information or an address capable of specifying a customer may be additionally included in the transaction.

For example, a method of adding previous transaction information for specifying the originator is as follows.

a. Method of Adding Previous Transaction Information (1100)

After generation of a first user confirmation transaction, a transaction ID of the first user confirmation transaction may be included in a second user confirmation transaction. Based on the transaction ID of the first user confirmation transaction, the originator may be specified on the O-VASP. Thereafter, a transaction ID of the second user confirmation transaction may be included in a virtual asset transfer transaction to thereby specify a virtual asset transfer transmission related to the second user confirmation transaction, so that the originator may be specified.

(2) Method of Adding Originator Personal Wallet Information (1150)

As another example, in order to specify the originator, information about a personal wallet of the originator may be additionally included in the first user confirmation transaction.

Since not only the information about the wallet address of the O-VASP but also the information about the personal wallet of the originator is included in the first user confirmation transaction, the originator may be specified.

The second user confirmation transaction may have the personal wallet of the originator specified thereon, so that the originator may be specified on the O-VASP.

The virtual asset transfer transaction may also include the information about the personal wallet of the originator, so that the originator may be specified.

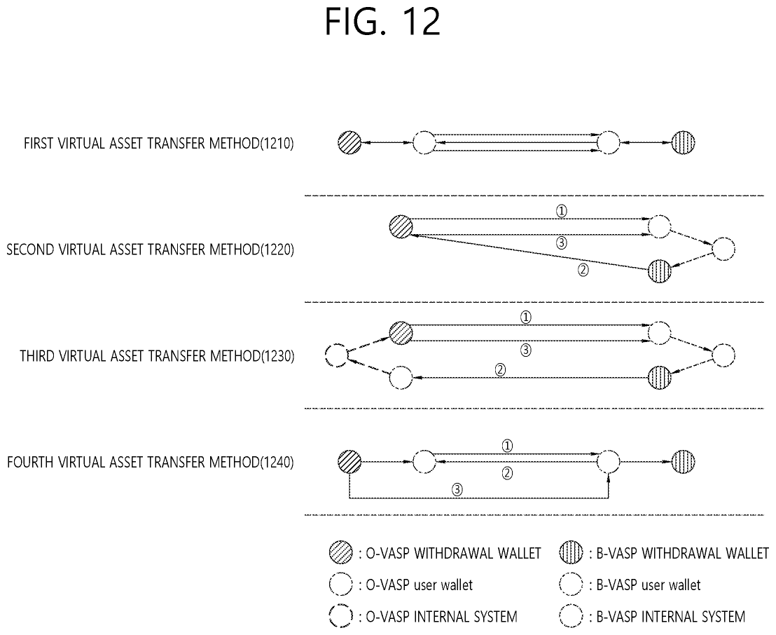

FIG. 12 is a conceptual diagram illustrating a virtual asset transfer method according to an embodiment of the present invention.

In FIG. 12, an embodiment of various virtual asset transfers is disclosed.

Referring to FIG. 12, a first virtual asset transfer method 1210, a second virtual asset transfer method 1220, a third virtual asset transfer method 1230, and a fourth virtual asset transfer method 1240 are disclosed.

The first virtual asset transfer method 1210 is a virtual asset transfer using a personal wallet of an originator and a personal wallet of a beneficiary. When the personal wallet of the originator and the personal wallet of the beneficiary are used, there is no specific issue regarding separate originators, and a first user confirmation transaction, a second user confirmation transaction, and a virtual asset transfer transaction may occur based on the personal wallet address of the originator and the personal wallet address of the beneficiary.

The second virtual asset transfer method 1220 is implemented to add a transaction ID of a first user confirmation transaction to a second user confirmation transaction so that the originator may be specified on the O-VASP, when a transaction is performed through the integrated wallet of the O-VASP.

The third virtual asset transfer method 1230 is implemented to add information about a personal wallet of an originator to a first user confirmation transaction and transmit the first user confirmation transaction, when a transaction is performed through the integrated wallet of the O-VASP. In a second user confirmation transaction, the originator may be specified based on the personal wallet of the originator to confirm the originator, and a virtual image transfer transaction may be performed in the integrated wallet of the O-VASP.

The fourth virtual asset transfer method 1240 is a method in which a first user confirmation transaction and a second user confirmation transaction are performed based on a personal wallet, and a virtual asset transfer transaction is performed through an integrated wallet of the O-VASP. That is, without adding additional information to a transaction, a personal wallet address of an originator is directly used as a sending address, and a personal wallet address of a beneficiary is directly used as a receiving address such that originator confirmation and beneficiary confirmation procedures based on the first user confirmation transaction and the second user confirmation transaction may be performed.

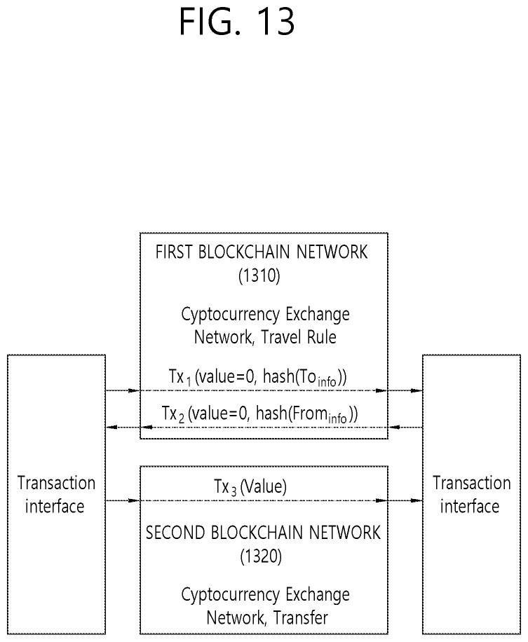

FIG. 13 is a conceptual diagram illustrating a virtual asset transfer method according to an embodiment of the present invention.

In FIG. 13, a virtual asset transfer method using different blockchain networks is disclosed.

Referring to FIG. 13, a specific blockchain (e.g., Bitcoin, Ethereum) has a limitation that a transaction transfer fee is high and it takes a long time for confirm a transaction. In addition, in data transfer, the design needs to be changed according to the characteristics of a main net.

Accordingly, a blockchain network for transmitting a first user confirmation transaction and a second user confirmation transaction and a blockchain network for transmitting virtual assets may be separately established.

The blockchain network for transmitting the first user confirmation transaction and the second user confirmation transaction may be called a first blockchain network 1310 or a blockchain network (user confirmation), and the blockchain network for transmitting the virtual asset transfer transaction may be called a second blockchain network 1320 or a blockchain network (virtual asset transfer).

In order to use different blockchain networks, when user confirmation is performed through the first blockchain network 1310, information about wallet addresses wallet(from) and wallet(To) of the originator and the beneficiary for the virtual asset transfer on the second blockchain network 1320 may be transmitted.

Tx1 (From=wallet (O-VASP), To=wallet(B-VASP), data={hash(To), wallet(from), wallet(To), Currency})

In addition, in order to perform a virtual asset transaction on the second blockchain network 1320, information about a transaction (the first user confirmation transaction and the second user confirmation transaction) (e.g., Txid (Tx2)) on the first blockchain network 1310 may be included.

Tx3 (From=wallet(O-VASP), To=wallet(To), data={hash(To), Txid(Tx2)})

The information about the transaction on the first blockchain network 1310 may selectively include information about the first user confirmation transaction and/or information about the second user confirmation transaction.

The embodiments of the present invention described above may be implemented in the form of program instructions that can be executed through various computer units and recorded on computer readable media. The computer readable media may include program instructions, data files, data structures, or combinations thereof. The program instructions recorded on the computer readable media may be specially designed and prepared for the embodiments of the present invention or may be available instructions well known to those skilled in the field of computer software. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a RAM, or a flash memory, that is specially made to store and execute the program instructions. Examples of the program instruction include machine code generated by a compiler and high-level language code that can be executed in a computer using an interpreter and the like. The hardware device may be configured as at least one software module in order to perform operations of embodiments of the present invention and vice versa.

While the present invention has been described with reference to specific details such as detailed components, specific embodiments and drawings, these are only examples to facilitate overall understanding of the present invention and the present invention is not limited thereto. It will be understood by those skilled in the art that various modifications and alterations may be made.

Therefore, the spirit and scope of the present invention are defined not by the detailed description of the present invention but by the appended claims, and encompass all modifications and equivalents that fall within the scope of the appended claims.

What is claimed is:

1. A method of identifying user information in a transaction, the method comprising:
transmitting, by an originator virtual asset service provider (O-VASP), a first user confirmation transaction to a beneficiary virtual asset service provider (B-VASP) based on remittance information;
receiving, by the O-VASP, a second user confirmation transaction from the B-VASP; and
transmitting, by the O-VASP, virtual transaction assets generated based on the remittance information to a beneficiary wallet.

2. The method of claim 1, wherein the first user confirmation transaction includes beneficiary identification information input by an originator device, and
the B-VASP determines whether the beneficiary identification information in the first user confirmation transaction is identical to beneficiary identification information stored in the B-VASP.

3. The method of claim 2, wherein the second user confirmation transaction includes originator identification information input by a beneficiary device, and
the O-VASP determines whether the originator identification information in the second user confirmation transaction is identical to originator identification information stored in the O-VASP.

4. An originator virtual asset service provider (O-VASP) for identifying user information in a transaction, the O-VASP comprising:
a communication unit configured to communicate with a beneficiary virtual asset service provider (B-VASP); and
a processor operatively connected to the communication unit,
wherein the processor is implemented to:
transmit a first user confirmation transaction to the B-VASP based on remittance information;
receive a second user confirmation transaction from the B-VASP; and
transmit virtual transaction assets generated based on the remittance information to a beneficiary wallet.

5. The O-VASP of claim 4, wherein the first user confirmation transaction includes beneficiary identification information input by an originator device, and
the B-VASP determines whether the beneficiary identification information in the first user confirmation transaction is identical to beneficiary identification information stored in the B-VASP.

6. The O-VASP of claim 5, wherein the second user confirmation transaction includes originator identification information input by a beneficiary device, and
the O-VASP determines whether the originator identification information in the second user confirmation transaction is identical to originator identification information stored in the O-VASP.
